(19) United States
(12) Patent Application Publication
(10) Pub. No.: US 2017/0027236 A1
(43) Pub. Date: Feb. 2, 2017

(54) Shirt with Lens Cloth

(71) Applicant: GOGGLE EYES, LLC, Miami, FL (US)

(72) Inventor: David B. Smith, Miami Beach, FL (US)

(73) Assignee: GOGGLE EYES, LLC, Miami, FL (US)

(21) Appl. No.: 14/815,178

(22) Filed: Jul. 31, 2015

(51) Int. Cl. A41B 1/08; G02C 13/00

(52) U.S. Cl. CPC A41B 1/08; G02C 13/006

(57) ABSTRACT

A shirt has a lens cloth for cleaning eyeglass lenses. The shirt is particularly useful for cleaning eyeglasses and sunglasses while boating and fishing. The lens cloth is disposed on an inside surface of the shirt so the lens cloth is not exposed to dirt, rain, and sea spray. The lens cloth can be placed on the interior of the torso of the shirt. The lens cloth extends upward from the bottom hemline of the front of the shirt. The lens cloth can reach a height that is lower than the waistline of the pants of a wearer. In this way, the lens cloth does not overly the skin of the wearer and remains clear of perspiration and sunscreen. To use the lens cloth, the front tail of the shirt is folded backward to expose the underlying lens cloth. In addition, a pocket can be formed on the shirt with a lens cloth held within the pocket. The lens cloth is kept clean by folding the lens cloth into the pocket. Then, when the lens cloth is to be used, the lens cloth is extended from the pocket and the eyeglass lenses are wiped with the lens cloth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

The invention relates to cloths for cleaning eyeglasses and shirts, and more particularly shirts to be worn while boating, fishing, exercising, surfing, and doing activities while wearing glasses or sunglasses.

Description of the Related Art

Sunglasses are particularly useful for boating and fishing because they can include polarized lenses that increase visibility of the water by reducing glare. Unfortunately, lenses of glasses and sunglasses become dirty when boating. Spray from the water dirties and spots lenses.

The problem is increased by sunscreen. Sunscreen is used when boating and fishing. The sunscreen spreads to the lenses of glasses and sunglasses through contact.

The problem of dirty eyeglass lenses and sunglass lenses is broader than just boating situations. Anyone who wears eyeglasses will acknowledge the problem with dirty lenses. These problems are worsened in situations when the wearer is perspiring or, as mentioned, when wearing sunscreen

For lightly dirty lenses, a wearer who is not boating can try to wipe his or her lenses clean using a shirt. However, using an ordinary shirt while fishing or boating to clean lenses usually makes the dirty lenses worse. First, the fabric itself does not absorb or hold the dirt, salt, and sunscreen. Second, the cloth itself is dirty and covered with sea spray, perspiration, and sunscreen.

One method for cleaning lenses is to wipe the lenses with a microfiber lens cleaning cloth. The lens-cleaning cloth can be kept in a wearer's sunglass case or pocket. When a case is used, the case may be off the wearer's body and difficult to reach when needed, especially if the wearer is spotting or retrieving a fish. When a cloth is placed in the pocket, the wearer must have two free hands to use the cloth: a first hand to hold the cloth and a second hand to hold the glasses.

### BRIEF SUMMARY OF THE INVENTION

An object of the invention is to provide a shirt with a lens cloth that overcomes the disadvantages of the devices of this general type and of the prior art. In particular, the shirt has a lens cloth that is protected from dirt, water, sea spray, perspiration, and sunscreen during normal wear and that is available when needed and can be used with only one hand. The lens cloth can be protected by an exterior layer for example an exterior of a shirt or pocket.

With the foregoing and other objects in view there is provided, in accordance with the invention, an improvement to a shirt. The improvement includes a lens cloth that is connected to the shirt. The lens cloth is hidden by the shirt when the shirt is worn. At the same time, the lens cloth is positioned so that it does not contact a wearer's skin when the shirt is worn.

A shirt can be a customary shirt. The shirt can be any type of shirt, for example, a crewneck shirt, a button-up shirt, a V-neck shirt, a hooded shirt, a long sleeve shirt, tank top, or a short-sleeve shirt. A shirt typically has a torso made from a back portion sewn to a front portion. In the case of a button-up shirt, the front portion can be separated into a left panel and a right panel. The shirt can be made of any suitable material. Cotton, nylon, polyester, and microfiber shirts are examples of materials.

In accordance with the objects of the invention, the shirt can include fabric having an outer surface configured to be worn facing away from skin of a wearer and an inner surface configured to be worn facing toward the skin of the wearer. The fabric can be the fabric of the shirt itself or the fabric that forms a pocket, in particular, a chest pocket. The lens cloth can be disposed on the inner surface of the fabric.

The shirt can include a torso portion. The torso covers the torso of the wearer. A hemline can be added along the bottom of the torso. The hemline prevents the shirt from fraying.

According to the objects of the invention, the lens cloth can be placed on the inside surface of the torso of the shirt with the bottom edge of the lens cloth being placed along the hemline. The hemline additionally can secure the lens cloth to the inside of the torso. The lens cloth can have a top edge. The height of the lens cloth can be set so that the top edge of the lens cloth is below the waistline of the pants of the wearer. Because the waistline of each particular wearer is expected to be different, the waistline can be based on sizing for average anatomy, average anatomy for a given shirt size, or by fitting a certain percentage of expected wearers. By keeping the top edge of the lens cloth below the waistline, the lens cloth does not contact the wearer's belly. Accordingly, the lens cloth does not absorb perspiration or sunscreen from the wearer's skin. In addition, the thickness of the shirt is kept at one layer thick on the wearer's skin by keeping the lens cloth below the waistline. The size and shape of the lens cloth can be set for a particular purpose. The lens cloth can be place along just the front and not the rear of the inside of a shirt above the hemline. The lens cloth can be sized and shaped that sewn or adhered as a patch placed on the inside of the shirt. The patch can be from the bottom of the shirt (i.e. along the hemline) and can reach to a level below the expected waistline of a wearer or reach even higher.

The lens cloth can be made from microfibers. Microfiber is synthetic fiber finer than one denier or decitex/thread. Types of microfibers that could be used include polyesters, polyamides, or a conjugation of polyester, polyamide, and polypropylene. An example of a suitable material for a lens cloth is the lens cloth sold under the trade name REUSABLE LENS CLEANING CLOTH 9021 by 3M.

The lens cloth can be placed on the inside of the tail of the shirt. A vent can be formed in the side of the shirt along the bottom of the shirt. The vent defines a tail in the front and back of the shirt. The lens cloth can be placed on the interior surface of the front tail of the shirt. To use the lens cloth, the tail is folded back to expose the lens cloth. Then, the wearer can use the exposed lens cloth to wipe his or her lenses.

In the case of a button-up shirt, the front of the shirt is divided into a right and left front panel. A lens cloth can be placed on the inside surface of each front panel.

The lens cloth can encircle the inside of the front and back of the shirt. However, only lining the front tail with the lens cloth may be preferred because the front tail is the most accessible portion and the rear section is unnecessary.

In accordance with the objects of the invention, a pocket can be formed with a lens cloth within the pocket. The pocket is a typical shirt pocket that is formed by sewing a flap of fabric onto the shirt. The flap is sewn along its left edge, bottom edge, and right edge. The top is open. A resealable closure can be added to the top of the pocket: for example, a button, a zipper, or hook and loop closure. The lens cloth is connected to an inner surface of the flap of fabric.

The lens cloth can be sewn to the inside top edge of the pocket. The lens cloth can be deployed by unfolding the lens cloth and extending it from the pocket. After using the lens cloth, the lens cloth can be folded into the pocket to protect the lens cloth from sea spray.

The pocket can be formed by attaching the lens cloth to the interior surface of the flap. The lens cloth can be the same size as the flap or larger. Larger lens clothes can be configured to extend above the top edge of the flap when the lens cloth is deployed for wiping liens. The lens cloth can be folded along the top edge so that the lens cloth is stored within the pocket when not in use.

Other features that are considered as characteristic for the invention are set forth in the appended claims.

Although the invention is illustrated and described herein as embodied in a shirt with a lens cloth, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a diagrammatic front view of a crew-neck embodiment of a shirt according to the invention; the lens cloth within the shirt is shown in phantom.

FIG. 2 is rear sectional view of the shirt shown in FIG. 1; the section is taken along line IV-IV in FIG. 3.

FIG. 3 is a left side view of the shirt shown in FIG. 1 that includes pants; the portion of the pants within the shirt and the lens cloth are shown in phantom.

FIG. 4 is a rear sectional view of the shirt shown in FIG. 1 that includes pants; the section is taken along line IV-IV in FIG. 3.

FIG. 5 is a front side view of a buttoned embodiment of a shirt according to the invention; the lens cloth within the shirt is shown in phantom.

FIG. 6 is a rear sectional view of the shirt shown in FIG. 5 taken along line XIII-XIII in FIG. 7.

FIG. 7 is a left side view of the shirt shown in FIG. 5 that includes pants; the portion of the pants within the shirt and the lens cloth are shown in phantom.

FIG. 8 is a rear section view of the shirt shown in FIG. 5 that includes pants; the section is taken along line XIII-XIII in FIG. 7.

FIG. 9 is a front side view of an embodiment of a pocket with a fold-out lens cloth; the lens cloth, which is retracted within the pocket, is shown in phantom.

FIG. 10 is a front side view of the pocket shown in FIG. 9 with the lens cloth deployed.

FIG. 11 is a side view of the pocket shown in FIG. 9 with the lens cloth deployed.

FIG. 12 is a front side view of an embodiment of a pocket with a lens-cloth liner.

FIG. 13 is a left side view of the pocket shown in FIG. 12.

FIG. 14 is a rear side view of the pocket shown in FIG. 12.

FIG. 15 is a front side view of an embodiment of a pocket with a lens-clothe liner and flap.

FIG. 16 is a rear side view of the pocket shown in FIG. 15 with the flap of the pocket shown in phantom.

FIG. 17 is a front side view of the pocket shown in FIG. 15 with the lens-cloth flap retracted.

FIG. 18 is a rear side view of the pocket shown in FIG. 15 with the lens-cloth flap retracted.

FIG. 19 is a left side view of the pocket shown in FIG. 15 with the lens-cloth flap deployed.

FIG. 20 is a left side view of the pocket shown in FIG. 15 with the lens-cloth flap retracted.

### DETAILED DESCRIPTION OF THE INVENTION

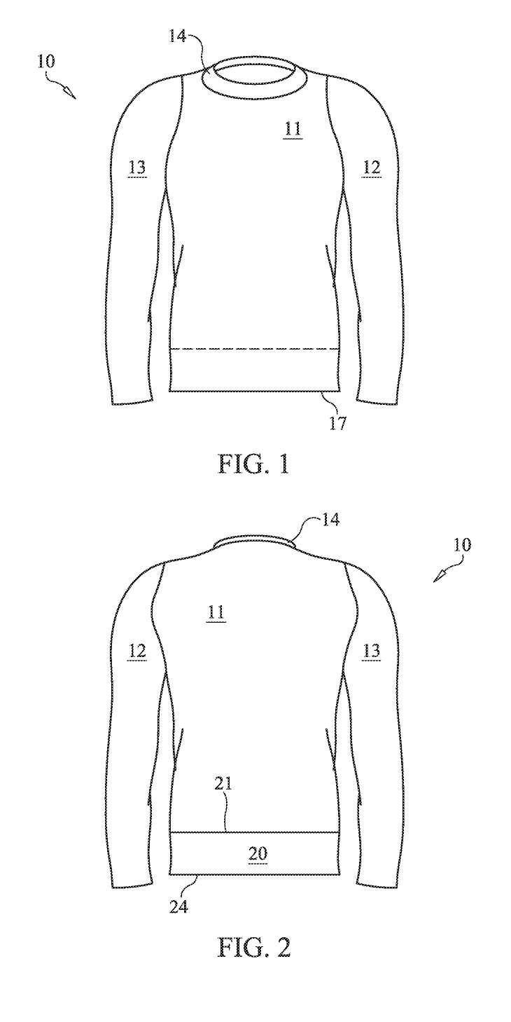

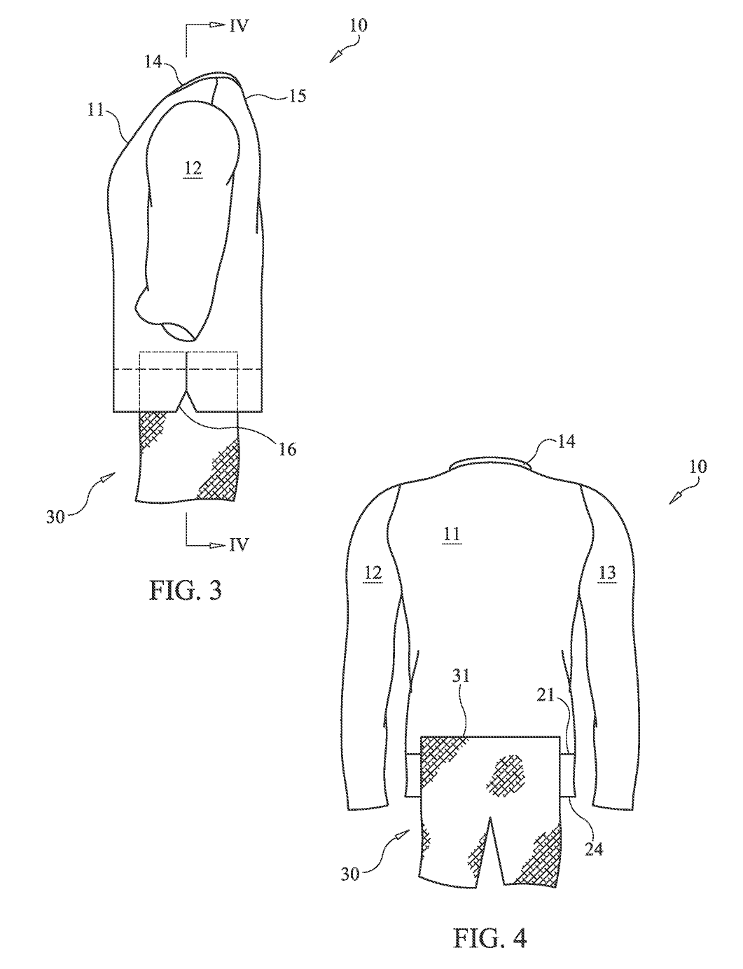

FIGS. 1-4 show a crewneck embodiment of the shirt. The shirt 10 includes a shirt front 11 and a shirt back 15. Together, the shirt front 11 and shirt back 15 define a torso of the shirt 10. A left sleeve 12 for receiving a left arm of a wearer is connected to the shirt front 11. A right sleeve 13 for receiving a right arm of the wearer is connected to the shirt front 11. A collar 14 is connected to the shirt front 11 and shirt back 15. A hemline 17 is formed along the bottom of the shirt front 11 and the shirt back 15. The shirt front 11 and shirt back 15 form a vent 16 at the bottom of each side of the shift 10.

FIG. 2 is a sectional view that shows the inside surface of the shirt front 11. A lens cloth 20 is stitched to the inside surface of the shirt front 11. The lens cloth 20 has a top hemline 21 and a bottom hemline 24. The bottom hemline 24 is formed along the hemline 17 of the shirt. Preferably, the lens cloth is stitched along the top hemline 21 and the bottom hemline 24 to the inside surface of the shirt front 11. The top hemline 21 is as tall as the vent 16.

The lens cloth 20 is preferably made of microfiber. The microfiber is preferably a blend of polyester and nylon.

FIG. 4 shows a rear sectional view of the crewneck shirt 10. Pants 30 of a wearer are shown. The pants 30 have a waistline 31 at their top. The shirt 10 and the lens cloth 20 are sized so that the top hemline 21 of the lens cloth 20 is below the waistline 31 of the shorts when the shirt 10 is worn.

To clean the lenses wearer's glasses, the wearer folds the tail of shirt front 11 to expose the lens cloth 20. The wearer then wipes his or her lenses on the lens cloth 20. After wiping the lenses, the tail of the shirt front 11 is released to hide the lens cloth 20.

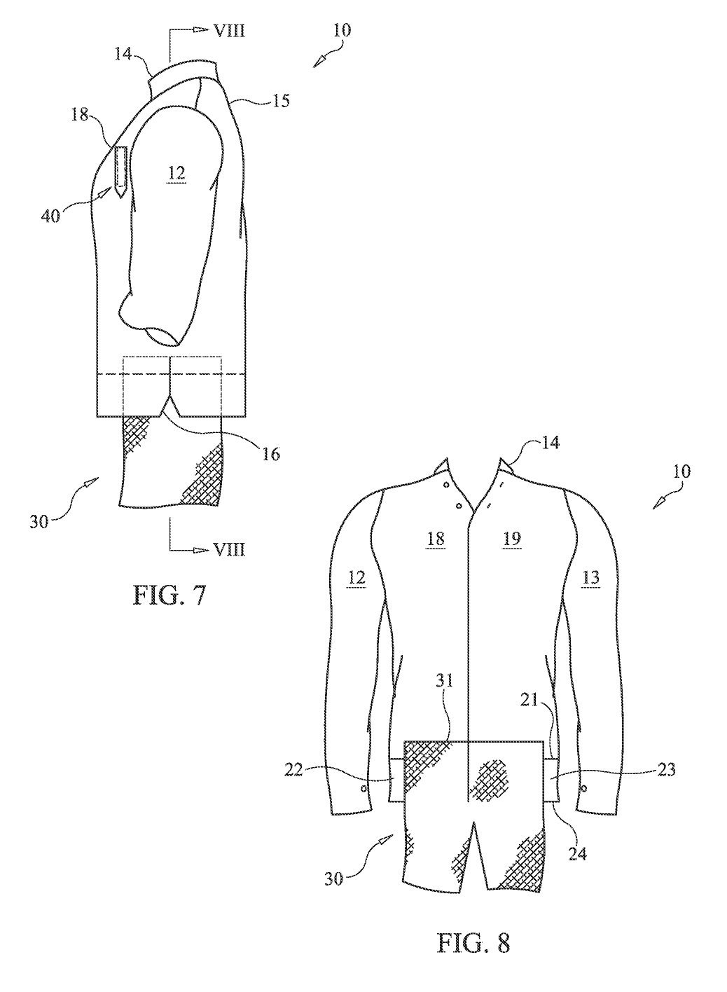

FIGS. 5-8 show a button-up embodiment of a shirt 10 with a lens cloth 20. The shirt 10 includes a left shirt front panel 18, a right shirt front panel 19, and a shirt back 15. Together, the left shirt front panel 18, the right shirt front panel 19, and the shirt back 15 define a torso of the shirt 10. A left sleeve 12 for receiving a left arm of a wearer is connected to the left shirt front panel 18 and the shirt back 15. A right sleeve 13 for receiving a right arm of the wearer is connected to the right shirt front panel 19 and the shirt back 15. A collar 14 is connected to the left shirt front panel 18, the right shirt front panel 19, and the shirt back 15. A hemline 17 is formed along the bottom of the left shirt front panel 18, the right shirt front panel 19, and the shirt back 15. The left shirt front panel 18 and the shirt back 15 form a vent 16 at the bottom of the left side of the shirt 10. The right shirt front panel 19 and the shirt back 15 form a vent, which is not shown, at the bottom of the right side of the shirt 10.

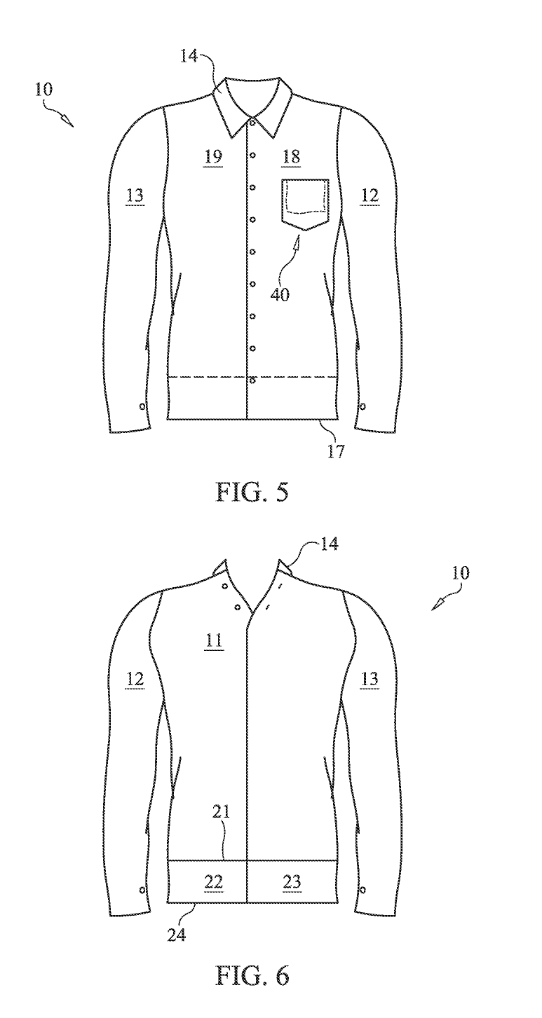

FIG. 6 is a sectional view that shows the inside surface of the left front shirt panel 18 and the inside surface of the right front shirt panel 19. A left panel 22 of the lens cloth 20 is stitched to the left front shirt panel 18. A right panel 23 of the lens cloth 20 is stitched to the right front shirt panel 19. The lens cloth 20 has a top hemline 21 and a bottom hemline 24. The bottom hemline 24 is formed along the hemline 17 of the shirt 10. The left panel 22 is stitched along the top hemline 21 and the bottom hemline 24 to the inside surface of the left front shirt panel 18. The right panel 22 is stitched along the top hemline 21 and the bottom hemline 24 to the inside surface of the right front shirt panel 19. The top hemline 21 is as tall as the vent 16.

The lens cloth 20 is preferably made of microfiber. The microfiber is preferably a blend of polyester and nylon.

FIG. 8 shows a rear sectional view of the button-up shirt 10. Pants 30 of a wearer are shown. The pants 30 have a waistline 31 at their top. The shirt 10 and the lens cloth 20 are sized so that the top hemline 21 of the lens cloth 20 is below the waistline 31 of the shorts when the shirt 10 is worn.

To clean the lenses wearer's glasses, the wearer folds the tail of the left front shirt panel 18 to expose the left panel 22 or the tail of the right front shirt panel 19 to expose the right panel 23. The wearer then wipes his or her lenses on the left panel 22 or the right panel 23. After wiping the lenses, the shirt tail is released to hide the left panel 22 or the right panel 23.

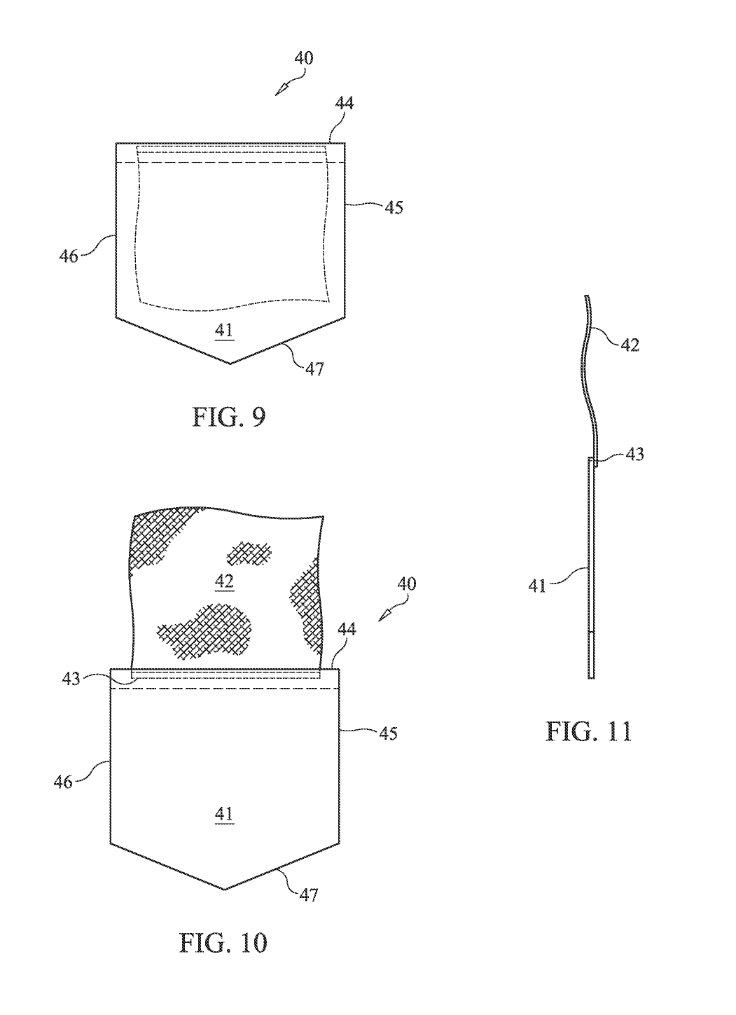

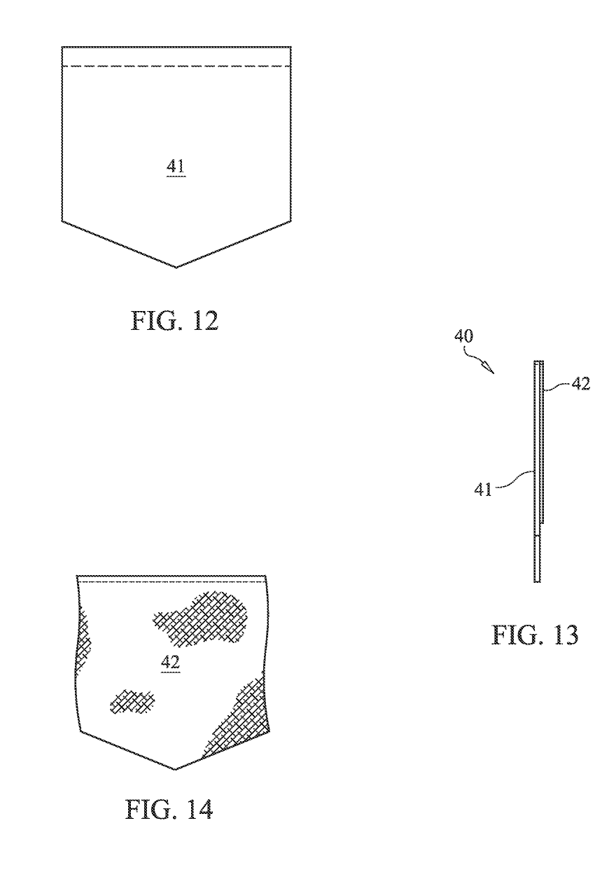

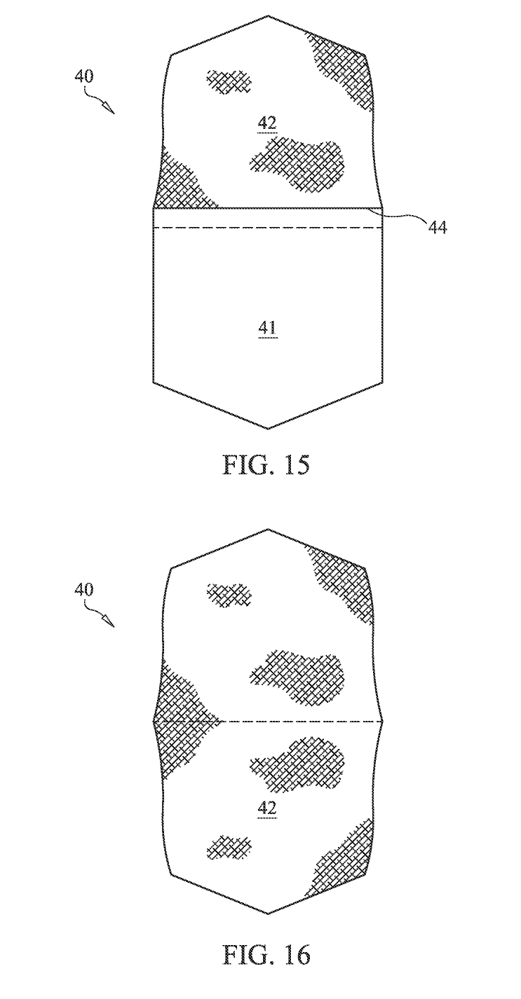

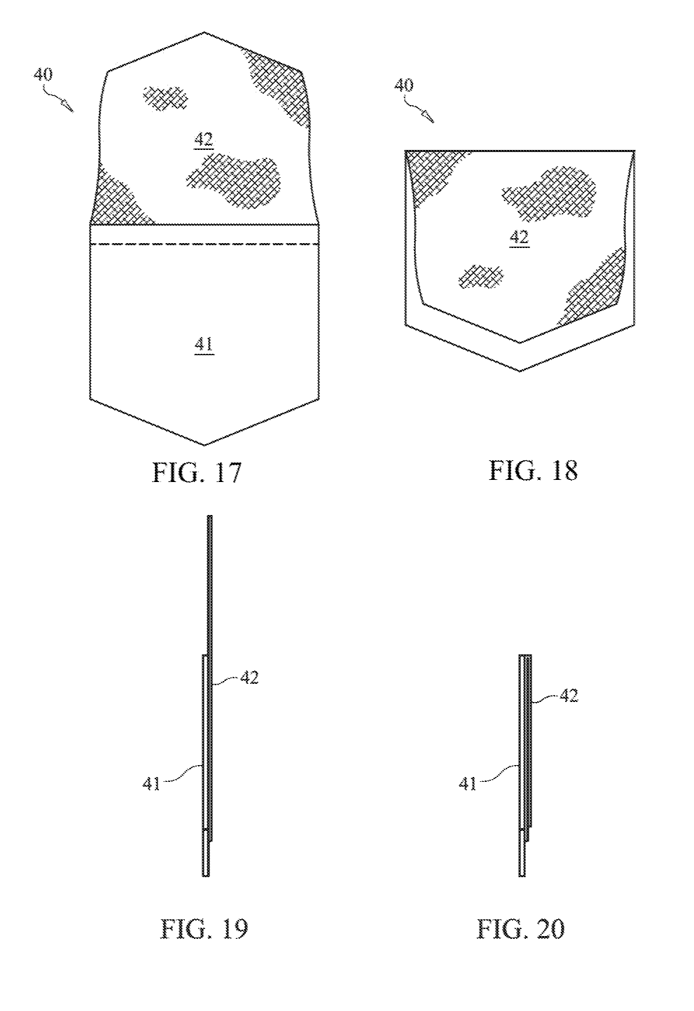

FIGS. 9-11 show an embodiment of a pocket 40. The pocket 40 includes a flap 41. The flap 41 has a top edge 44, left edge 45, right edge 46, and bottom edge 47. The flap 41 is sewn along its left edge 45, right edge 46, and bottom edge 47 onto the left front shirt panel 18 to form the pocket 40. The lens cloth 42 is sewn along the hem 43 to the top edge 44 of the flap 41.

To use the pocket shown in FIGS. 9-11, the wearer deploys the lens cloth 42 from the position shown in FIG. 9 to the position shown in FIGS. 10-11. The lens cloth can then be used to clean the wearer's lenses. When completed, the lens cloth 42 is tucked into the pocket 40.

What is claimed is:

1. In a shirt, the improvement comprising a lens cloth being connected to said shirt, said lens cloth being hidden by the shirt when the shirt is worn; said lens cloth not contacting a wearer's skin when the shirt is worn.

2. A shirt for cleaning lenses, comprising:
fabric having an outer surface configured to be worn facing away from skin of a wearer and an inner surface configured to be worn facing toward the skin of the wearer; and
a lens cloth disposed on said inner surface.

3. The shirt according to claim 2, wherein said fabric forms a torso.

4. The shirt according to claim 3, wherein:
said torso has a hemline;
said lens cloth has a bottom edge; and
said bottom edge lies along said hemline.

5. The shirt according to claim 3, wherein:
said lens cloth has a top edge; and
said top edge is configured to be below a waistline of a wearer.

6. The shirt according to claim 2, wherein said lens cloth is made from microfibers.

7. The shirt according to claim 6, wherein said microfibers are microfibers selected from the group consisting of polyesters, polyamides, and a conjugation of polyester, polyamide, and polypropylene microfibers.

8. The shirt according to claim 2, wherein:
said torso includes a left front shirt panel and a right front shirt panel;
said lens cloth includes a left cuff panel and right cuff panel;
said left cuff panel is disposed on said left front shirt panel; and
said right cuff panel is disposed on said right front shirt panel.

9. The shirt according to claim 2, wherein:
the fabric forms a flap of a pocket; and
said lens cloth is connected to said inner surface.

10. The shirt according to claim 9, further comprising stitching interconnecting said lens cloth and said flap.

11. The shirt according to claim 9, wherein said lens cloth lines said flap.

12. The shirt according to claim 9, wherein said flap has a top edge; and said lens cloth is extendable above said top edge.

13. The shirt according to claim 12, wherein said lens cloth is retractable to be held within said pocket and below said top edge.
